(19) United States
(12) Patent Application Publication
(10) Pub. No.: US 2016/0138959 A1
(43) Pub. Date: May 19, 2016

(54) CONSERVATOR

(71) Applicant: MITSUBISHI ELECTRIC CORPORATION, Chiyoda-ku, Tokyo (JP)

(72) Inventors: Kenichi MINO, Chiyoda-ku, Tokyo (JP); Ryuichi NISHIURA, Chiyoda-ku, Tokyo (JP); Toshiki IDEMARU, Chiyoda-ku, Tokyo (JP)

(73) Assignee: Mitsubishi Electric Corporation, Chiyoda-ku, Tokyo, (JP)

(21) Appl. No.: 14/903,080

(22) PCT Filed: Jul. 9, 2013
(86) PCT No.: PCT/JP2013/068709

§ 371 Date: Jan. 6, 2016

(51) Int. Cl. G01F 23/34

(52) U.S. Cl. CPC G01F 23/34

(57) ABSTRACT

The conservator is provided with a housing that houses an insulation oil, a rubber bag that inflates or deflates inside the housing so as to contact an oil surface of the insulation oil, and an oil level gauge that detects the oil level of the insulation oil housed inside the housing. The oil level gauge includes a float member, an arm connected to one end of the float member, and a dial display unit that displays an oil level in response to an angle of the arm. The float member is swingably connected to the arm, extending away from the arm along the lower surface of the rubber bag. The length of the float member in the extending direction thereof is larger than the maximum thickness of the float member.

### TECHNICAL FIELD

The present invention relates to a conservator, and in particular, relates to a conservator provided with an oil level gauge.

### BACKGROUND ART

As a prior art, Japanese Patent Laying-Open No. 2012-147582 (PTD 1) discloses a conservator equipped with a liquid level gauge. The liquid level gauge disclosed in PTD 1 is disposed in the conservator as a detector for detecting an abnormality in an insulating spacer, and is provided with a float having a circular shape in profile.

As a prior art, Japanese Utility Model Laying-Open No. 6-31118 (PTD 2) discloses a conservator equipped with an oil level gauge including a plate-shaped float. The oil level gauge disclosed in PTD 2 for a conservator is a supersonic wave-typed oil level gauge in which a plate-shaped float is attached to a bottom surface of a diaphragm opposite to the supersonic wave-typed oil level gauge, and is immersed in an insulation oil so as to constantly maintain horizontal the bottom surface of the diaphragm which serves as a reflection surface.

### CITATION LIST

### Patent Document

PTD 1: Japanese Patent Laying-Open No. 2012-147582

PTD 2: Japanese Utility Model Laying-Open No. 6-31118

### SUMMARY OF INVENTION

### Technical Problem

As a float to be used in an oil level gauge, it is necessary for it to have at least a certain volume so as to obtain sufficient buoyancy in an insulation oil. Therefore, in the case of the float having a circular shape in profile described in PTD 1, the necessary volume is provided by increasing the diameter of the float.

However, increasing the diameter of the float having a circular shape in profile results in increasing a dead region where the oil level of the insulation oil is undetectable. Specifically, in the case where the amount of the insulation oil in the conservator is less, the oil level of the insulation oil may be lower than the diameter of the float. In this case, since the float cannot move in response to the oil level in the conservator, the oil level of the insulation oil is undetectable. Since a larger diameter of a float increases the dead region where the oil level is undetectable, an extra amount of insulation oil is needed, and thereby, the conservator must be made larger accordingly so as to house therein that extra amount of insulation oil.

In the oil level gauge disclosed in PTD 2, the plate-shaped float is fixed directly to the lower surface of the rubber bag, and is adapted to be used only in an ultrasonic oil level gauge. Therefore, it is not considered to be used in a dial oil level gauge which is cheaper than the ultrasonic fuel level meter.

The present invention has been made in view of the above problems, and an object thereof is to provide a compact and cheap conservator with a reduced dead region.

### Solution to Problem

The conservator according to the present invention is provided with a housing that houses an insulation oil, a rubber bag that inflates or deflates inside the housing so as to contact an oil surface of the insulation oil, and an oil level gauge that detects an oil level of the insulation oil housed inside the housing. The oil level gauge includes a float member, an arm connected to one end of the float member, and a dial display unit that displays an oil level in response to an angle of the arm. The float member is swingably connected to the arm and extends away from the arm along the lower surface of the rubber bag. The length of the float member in the extending direction thereof is larger than the maximum thickness of the float member.

### Advantageous Effects of Invention

According to the present invention, it is possible to make the conservator compact and cheap while reducing the dead region.

### BRIEF DESCRIPTION OF DRAWINGS

FIG. 1 is a sectional view illustrating the configuration of a conservator according to a first embodiment of the present invention;

FIG. 2 is a view illustrating the outer appearance of a dial display unit viewed from the direction of an arrow II in FIG. 1;

FIG. 3 is a sectional view illustrating the conservator in a state where an insulation oil is filled to an upper limit of a display range by the dial display unit;

FIG. 4 is a view illustrating the outer appearance of a dial display unit viewed from the direction of an arrow IV in FIG. 3;

FIG. 5 is a sectional view illustrating the conservator in a state where the insulation oil flows out to a lower limit of the display range by the dial display unit;

FIG. 6 is a view illustrating the outer appearance of a dial display unit viewed from the direction of an arrow VI in FIG. 5;

FIG. 7 is a planar view illustrating the configuration of a float unit according to the first embodiment;

FIG. 8 is a view illustrating the float unit viewed from the direction of an arrow VIII in FIG. 7;

FIG. 9 is a view illustrating a state in which an arm is swung relative to the float unit according to the first embodiment;

FIG. 10 is a planar view illustrating the configuration of a float unit of an oil level gauge in a conservator according to a second embodiment of the present invention;

FIG. 11 is a view illustrating the float unit from the direction of an arrow XI in FIG. 10;

FIG. 12 is a view illustrating a state in which an arm is swung relative to the float unit according to the second embodiment;

FIG. 13 is a planar view illustrating the configuration of a float unit of an oil level gauge in a conservator according to a third embodiment of the present invention;

FIG. 14 is a view illustrating the float unit viewed from the direction of an arrow XIV in FIG. 13;

FIG. 15 is a view illustrating a state in which an arm is swung relative to the float unit according to the third embodiment;

FIG. 16 is a planar view illustrating the configuration of a float unit of an oil level gauge in a conservator according to a fourth embodiment of the present invention;

FIG. 17 is a view illustrating the float unit viewed from the direction of an arrow XVII in FIG. 16; and

FIG. 18 is a view illustrating a state in which an arm is swung relative to the float unit according to the fourth embodiment.

### DESCRIPTION OF EMBODIMENTS

Hereinafter, a conservator according to a first embodiment of the present invention will be described with reference to the drawings. In the description of the following embodiments, the same or corresponding portions in the drawings will be assigned with the same reference numerals, and the description thereof will not be repeated.

### First Embodiment

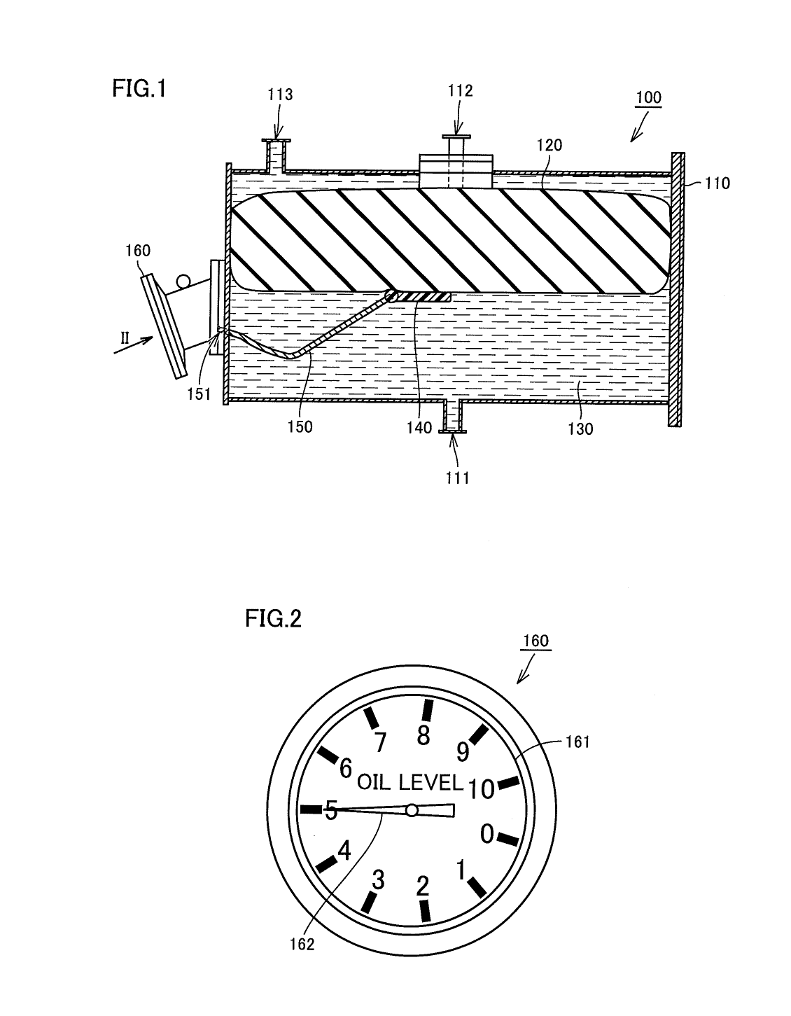

FIG. 1 is a sectional view illustrating the configuration of a conservator according to the first embodiment of the present invention. FIG. 2 is a view illustrating the outer appearance of a dial display unit viewed from the direction of an arrow II in FIG. 1. In FIG. 1, an insulation oil is filled to approximately a half of the housing.

As illustrated in FIG. 1, a conservator 100 according to the first embodiment of the present invention includes a housing 110 that houses an insulation oil 130, a rubber bag 120 that inflates or deflates inside housing 110 so as to contact an oil surface of insulation oil 130, and an oil level gauge that detects an oil level of insulation oil 130 housed in housing 110.

The bottom surface of housing 110 is provided with a flange 111 to be connected by a connection pipe connected to a tank that houses a stationary induction apparatus such as a transformer. The top center of housing 110 is provided with an open valve 112 which is connected to the mouth of rubber bag 120. The top of housing 110 is provided an opening 113 for releasing air out of housing 110.

The internal space of housing 110 is divided into two parts by rubber bag 120. A part of the internal space of housing 110 outside rubber bag 120 is filled with insulation oil 130, and the other part of the internal space of housing 110 inside rubber bag 120 is filled with air at atmospheric pressure.

Specifically, after injecting a certain amount of insulation oil 130 into housing 110, air is pumped into rubber bag 120 from open valve 112 to inflate rubber bag 120, and thereby, the air inside housing 110 is released from opening 113. Thereafter, opening 113 is closed, and thereby, in housing 110, the inside space of rubber bag 120 is filled with air, and the outside space of rubber bag 120 is filled with insulation oil 130.

The oil level gauge includes a float unit 140, an arm 150 connected to one end of float unit 140, and a dial display unit 160 that displays an oil level in response to an angle of arm 150. Dial display unit 160 is disposed on a side surface of housing 110.

Float unit 140 is swingably connected to arm 150 and extends to the right in the drawing, in other words, to a direction away from arm 150 along a lower surface of rubber bag 120. The length of float unit 140 in the extending direction thereof is greater than the maximum thickness of float unit 140.

Arm 150 has a bent shape. A swing fulcrum 151 is provided at one end of arm 150, serving as a fulcrum for swinging arm 150. One end of arm 150 is connected to a gear (to be described later) of dial display unit 160 located outside housing 110. The other end of arm 150 is connected to one end of float unit 140.

As illustrated in FIG. 2, dial display unit 160 includes a disc shaped character display face 161 labeled with oil levels, and a pointer 162. Pointer 162 is connected to a gear (not shown). The gear is connected to one end of arm 150 illustrated in FIG. 1. Dial display unit 160 is configured to magnify an angle displacement of aim 150 through the gear and display the oil level in accordance with the angle of arm 150 through pointer 162.

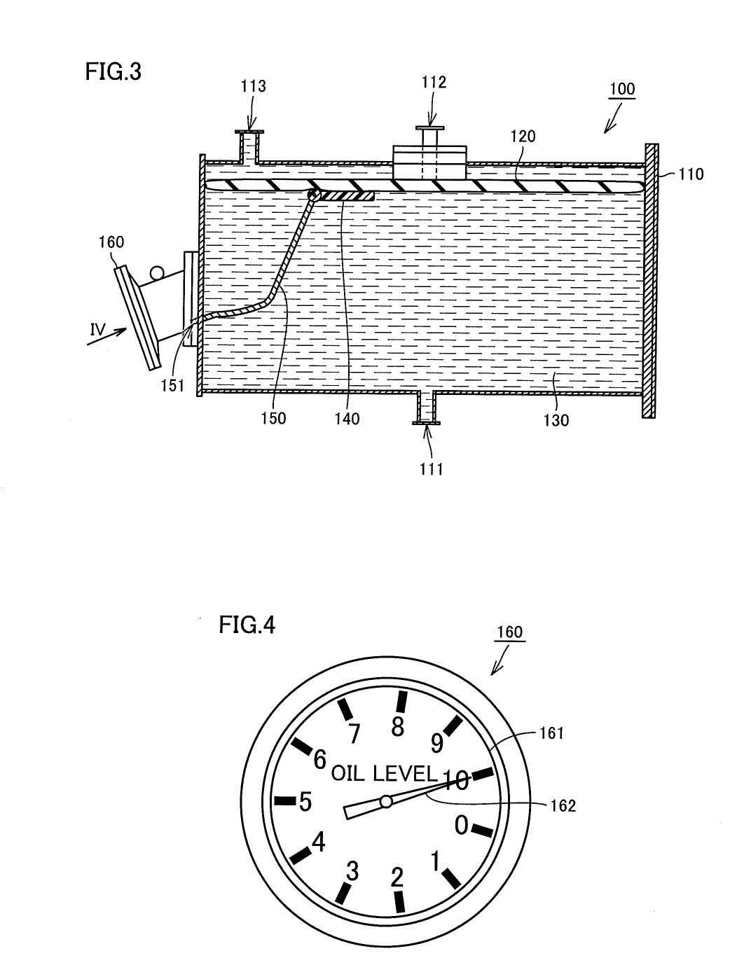

FIG. 3 is a sectional view illustrating the conservator in a state where the insulation oil is filled to an upper limit of a display range by the dial display unit. FIG. 4 is a view illustrating the outer appearance of the dial display unit viewed from the direction of an arrow IV in FIG. 3.

In the case where the stationary induction apparatus continues to work at a high load, the temperature of insulation oil 130 rises, causing insulation oil 130 to expand. As a result, insulation oil 130 flows from the tank into housing 110 through the connecting pipe. As illustrated in FIG. 3, as insulation oil 130 flows from the connecting pipe into conservator 100, rubber bag 120 is deflated by the inflow insulation oil 130, and thereby, the air in rubber bag 120 is released out through open valve 112. Thus, the pressure in rubber bag 120 is maintained at atmospheric pressure.

As illustrated in FIGS. 3 and 4, if all air in rubber bag 120 is substantially released, pointer 162 of dial display unit 160 points to an oil level of 10, which is the upper limit of the display range.

Thus, as insulation oil 130 flows into housing 110, causing the oil level to rise, float unit 140 rises in response to the rise of the oil level. Therefore, arm 150 connected to one end of float unit 140 swings counterclockwise around swing fulcrum 151.

As described above, since float unit 140 is swingably connected to arm 150, during the process in which the inflow of insulation oil 130 deflates rubber bag 120, float unit 140 slides to the left side of the drawing along the lower surface of rubber bag 120, and maintains at the state extending away from arm 150. Thus, it is possible to prevent float unit 140 from partially contacting rubber bag 120 so as to prevent a pressing force against the contact surface from increasing.

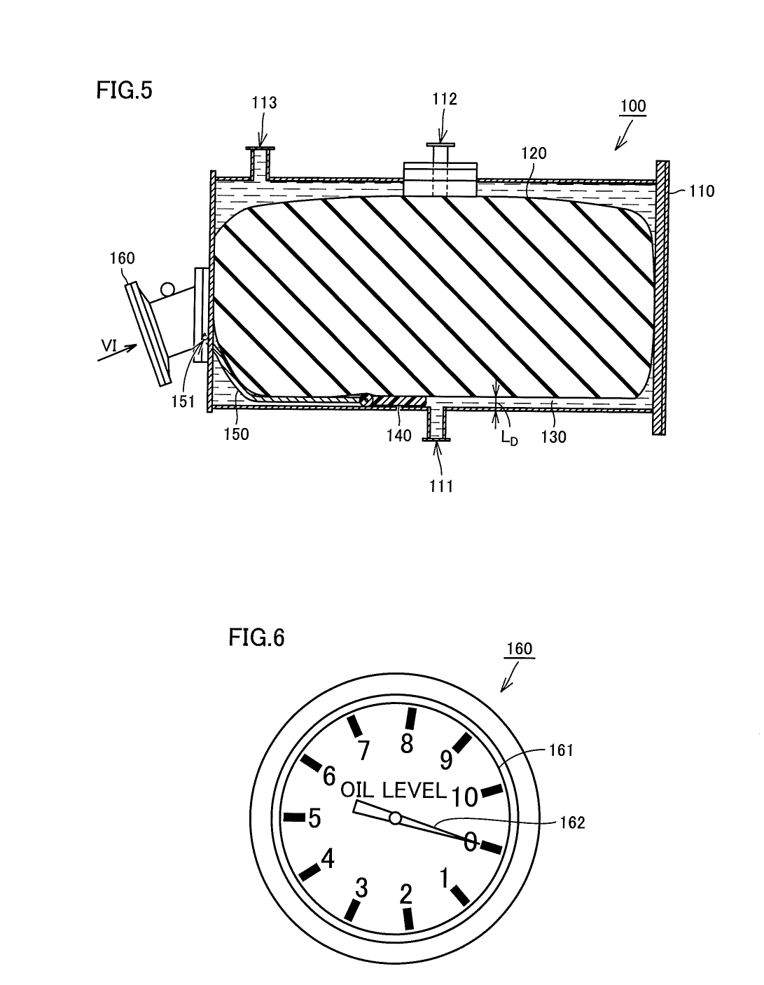

FIG. 5 is a sectional view illustrating the conservator in a state where the insulation oil flows out to a lower limit of the display range by the dial display unit. FIG. 6 is a view illustrating the outer appearance of the dial display unit viewed from the direction of an arrow VI in FIG. 5.

In the case where the stationary induction apparatus is not working and the outside air temperature is low, the temperature of insulation oil 130 decreases, causing insulation oil 130 to shrink. As a result, insulation oil 130 in housing 110 flows out into the tank through the connecting pipe. As illustrated in FIG. 5, as insulation oil 130 in conservator 100 flows out through the connecting pipe, rubber bag 120 is inflated due to the pressure difference between the inside and the outside of rubber bag 120. At this time, air flows into rubber bag 120 through open valve 112, and the pressure in rubber bag 120 is maintained at atmospheric pressure.

As illustrated in FIGS. 5 and 6, in a state where float unit 140 is being sandwiched between the bottom surface of housing 110 and the lower surface of rubber bag 120, pointer 162 of dial display unit 160 points to an oil level of 0, which is the lower limit of the display range. At this time, the region having a height L_{D} between the bottom surface of housing 110 and the lower surface of rubber bag 120 becomes the dead region where the oil level is undetectable by the oil level gauge of conservator 100 according to the present embodiment.

It is preferable that arm 150 shapes in accordance with the shape of rubber bag 120 as float unit 140 is being sandwiched between the bottom surface of housing 110 and the lower surface of rubber bag 120.

Thus, as insulation oil 130 flows out from housing 110, the oil level descends, and float unit 140 descends in response to the descent of the oil level. Therefore, arm 150 connected to one end of float unit 140 swings clockwise around swing fulcrum 151.

As described above, since float unit 140 is swingably connected to aim 150, during the process in which insulation oil 130 flows out and thereby rubber bag 120 is inflated, float unit 140 slides to the right side of the drawing along the lower surface of rubber bag 120, and maintains at the state extending away from arm 150. Thus, it is possible to prevent float unit 140 from partially contacting rubber bag 120 so as to prevent a pressing force against the contact surface from increasing.

Float unit 140 is configured to extend along the lower surface of rubber bag 120 away from arm 150, and the extending length of float unit 140 is set larger than the maximum thickness of float unit 140, it is possible to reduce the thickness of float unit 140 while ensuring a certain volume so as to obtain sufficient buoyancy in insulation oil 130, which allows to reduce height L_{D}, i.e., the range of the dead region.

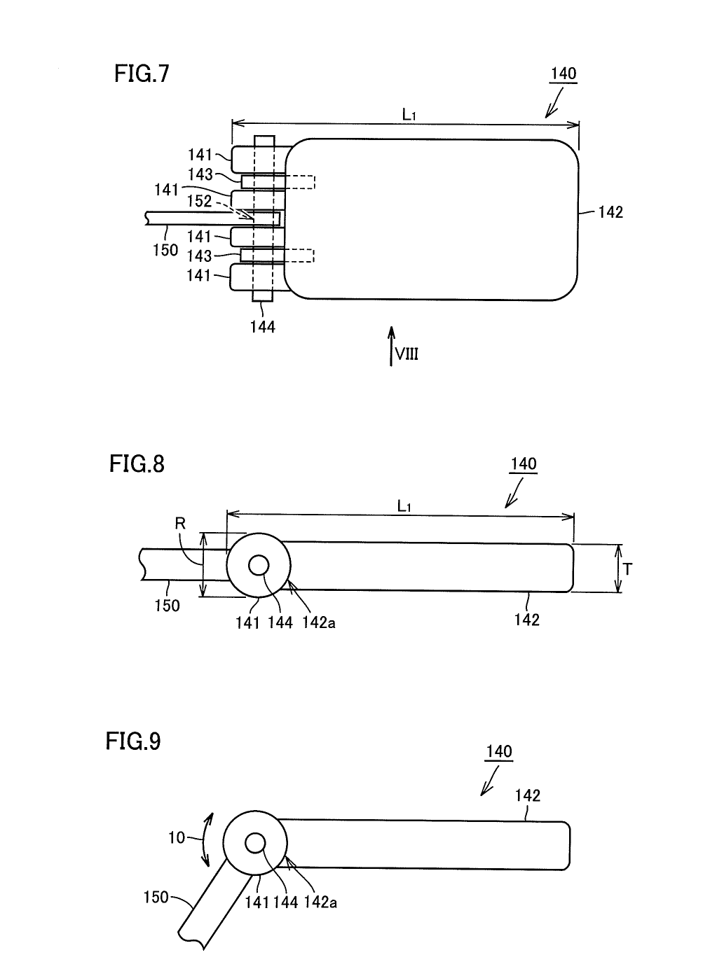

Hereinafter, the detailed configuration of float unit 140 according to the present embodiment will be described. FIG. 7 is a planar view illustrating the configuration of the float unit according to the present embodiment. FIG. 8 is a view illustrating the float unit viewed from the direction of an arrow VIII in FIG. 7. FIG. 9 is a view illustrating a state in which the arm is swung relative to the float unit of the present embodiment. FIG. 9 is viewed from the same direction as FIG. 8.

As illustrated in FIGS. 7 and 8, float unit 140 includes a plate-shaped float member 142, and a first pin 144 of a cylindrical shape which serves as a first shaft member provided at one end of plate-shaped float member 142 and configured to join plate-shaped float member 142 and arm 150 in such a manner that they are swingable to each other.

The other end of arm 150 is provided with a through hole 152 penetrating arm 150 in a direction perpendicular to the swinging direction of arm 150. Two joining members 143 are located at one end of plate-shaped float member 142 with a distance separating each other in the width direction of plate-shaped float member 142. Each of the two joining members 143 is formed with a through hole penetrating plate-shaped float member 142 in the width direction thereof.

In the present embodiment, each joining member 143 and plate-shaped float member 142 are made integral through insert molding but not limited thereto, for example, each joining member 143 may be bulged from one end of plate-shaped float member 142. That is to say, plate-shaped float member 142 and joining members 143 may be formed from the same material integrally.

The diameter of through hole 152 of arm 150 and the diameter of the through hole of each joining member 143 each is made slightly larger than the diameter of first pin 144. Thus, after locating the other end of arm 150 between joining members 143, first pin 144 is inserted into through hole 152 of arm 150 and the through holes of the two joining members 143, and thereby, float unit 140 can be connected to arm 150, swingable relative to arm 150 as indicated by an arrow 10 in FIG. 9. Note that both ends of first pin 144 are swaged so as to prevent the same from falling off.

In the present embodiment, float unit 140 further includes a first roller-shaped float member 141 rotatably inserted around first pin 144. Specifically, there are four of first roller-shaped float members 141 which are inserted through by first pin 144. The diameter R of each first roller-shaped float member 141 is greater than the thickness T of plate-shaped float member 142.

The four of first roller-shaped float members 141 are arranged in such a manner that one is close to one end of first pin 144, one is between one joining member 143 and arm 150, one is between arm 150 and the other joining member 143, and the last one is close to the other end of first pin 144. However, the number of first roller-shaped float members 141 is not limited to four, it may be one or more.

One end of plate-shaped float member 142 is foamed with a curved surface 142a which curves in accordance with the outer shape of first roller-shaped float member 141. A length L₁ between a tangent line to the outer edge of first roller-shaped float member 141 disposed at one end of plate-shaped float member 142 and the other end of plate-shaped float member 142 opposite to the end where first roller-shaped float member 141 is disposed is defined as the extending length of float unit 140.

As described above, the extending length of float unit 140 is greater than the maximum thickness of float unit 140. In other words, the extending length L₁ of float unit 140 is greater than the diameter R of first roller-shaped float member 141.

Thus, by configuring float unit 140 in such a manner, when float unit 140 is sliding along the lower surface of rubber bag 120, first roller-shaped float members 141 can contact rubber bag 120 by rolling against the lower surface thereof. As a result, it is possible to reduce the frictional resistance when float unit 140 is sliding along the lower surface of rubber bag 120. Thus, it is possible to prevent rubber bag 120 from being worn out.

Further, by increasing the extending length of float unit 140 while reducing the maximum thickness thereof, it is possible to ensure float unit 240 a certain volume so as to obtain sufficient buoyancy in insulation oil 130. As a result, it is possible to reduce the dead region of the oil level gauge. The reduction of the dead zone allows to make housing 110 smaller, and thereby making the conservator compact. In addition, it is also possible to reduce the required amount of insulation oil 130. Furthermore, the adoption of a dial typed oil level gauge allows to produce the conservator cheaper.

Hereinafter, a conservator according to a second embodiment of the present invention will be described with reference to the drawings. It should be noted that since the conservator according to the present embodiment is different from the conservator according to the first embodiment only in the configuration of the float unit, the descriptions about the other components will not be repeated.

### Second Embodiment

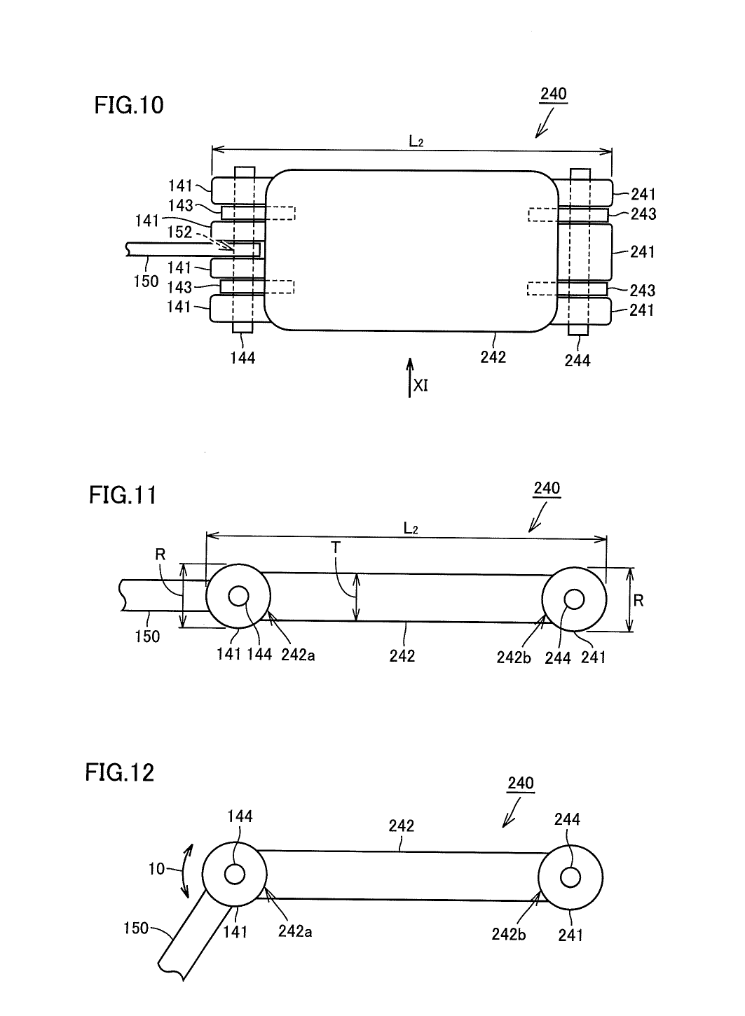

FIG. 10 is a planar view illustrating the configuration of a float unit of an oil level gauge in a conservator according to the second embodiment of the present invention. FIG. 11 is a view illustrating the float unit from the direction of an arrow XI in FIG. 10. FIG. 12 is a view illustrating a state in which an arm is swung relative to the float unit according to the second embodiment. FIG. 12 is viewed from the same direction as FIG. 11.

As illustrated in FIGS. 10 and 11, a float unit 240 includes a plate-shaped float member 242, and first pin 144 of a cylindrical shape which serves as a first shaft member provided at one end of plate-shaped float member 242 and configured to join plate-shaped float member 242 and arm 150 in such a manner that they are swingable to each other.

The other end of arm 150 is provided with a through hole 152 penetrating arm 150 in a direction perpendicular to the swinging direction of arm 150. Two joining members 143 are located at one end of plate-shaped float member 242 with a distance separating each other in the width direction of plate-shaped float member 242. Each of the two joining members 143 is formed with a through hole penetrating plate-shaped float member 242 in the width direction thereof.

Float unit 240 further includes a second pin 244 which serves as a second shaft part provided at the other end of plate-shaped float member 242 in parallel to first pin 144. Two joining members 243 are located at the other end of plate-shaped float member 242 with a distance separating each other in the width direction of plate-shaped float member 242. Each of the two joining members 243 is formed with a through hole penetrating plate-shaped float member 242 in the width direction thereof. The diameter of the through hole of each joining member 243 is slightly larger than the diameter of second pin 244.

In the present embodiment, each joining member 143, each joining member 243 and plate-shaped float member 242 are made integral through insert molding but not limited thereto, for example, each joining member 143 and each joining member 243 may be bulged respectively from both ends of plate-shaped float member 142. That is to say, plate-shaped float member 242 and joining members 143, 243 may be formed from the same material integrally.

The diameter of through hole 152 of arm 150 and the diameter of the through hole of each joining member 143 each is made slightly larger than the diameter of first pin 144. Thus, after locating the other end of arm 150 between joining members 143, first pin 144 is inserted into through hole 152 of arm 150 and the through holes of the two joining members 143, and thereby, float unit 240 can be connected to arm 150, swingable relative to arm 150 as indicated by arrow 10 in FIG. 12. Note that both ends of first pin 144 are swaged so as to prevent the same from falling off.

In the present embodiment, float unit 240 further includes first roller-shaped float member 141 rotatably inserted around first pin 144. Specifically, there are four of first roller-shaped float members 141 which are inserted through by first pin 144. The diameter R of each first roller-shaped float member 141 is greater than the thickness T of plate-shaped float member 142.

The four of first roller-shaped float members 141 are arranged in such a manner that one is close to one end of first pin 144, one is between one joining member 143 and arm 150, one is between arm 150 and the other joining member 143, and the last one is close to the other end of first pin 144. However, the number of first roller-shaped float members 141 is not limited to four, it may be one or more.

In the present embodiment, float unit 240 further includes a second roller-shaped float member 241 rotatably inserted around second pin 244. Specifically, there are three of second roller-shaped float members 241 which are inserted through by second pin 244. The diameter R of each second roller-shaped float member 241 is greater than the thickness T of plate-shaped float member 242. However, the number of second roller-shaped float members 241 is not limited to three, it may be one or more.

The three of second roller-shaped float members 241 are arranged in such a manner that one is close to one end of second pin 244, one is between two adjacent joining members 243, and the last one is close to the other end of second pin 244. Second pin 244 is inserted into the through holes of the two joining members 243, and both ends of second pin 244 are swaged so as to prevent the same from falling off.

One end of plate-shaped float member 242 is formed with a curved surface 242a which curves in accordance with the outer shape of first roller-shaped float member 141. The other end of plate-shaped float member 242 is formed with a curved surface 242b which curves in accordance with the outer shape of second roller-shaped float member 241. A length L₂ between a tangent line to the outer edge of first roller-shaped float member 141 disposed at one end of plate-shaped float member 242 and a tangent line to the outer edge of second roller-shaped float member 241 disposed at the other end of plate-shaped float member 242 is defined as the extending length of float unit 240.

As described above, the extending length of float unit 240 is greater than the maximum thickness of float unit 240. In other words, the extending length L₂ of float unit 240 is greater than the diameter R of each of first roller-shaped float members 141 and each of second roller-shaped float members 241.

In the present embodiment, although the diameter of first roller-shaped float member 141 is configured to be the same as the diameter of second roller-shaped float member 241 but not limited thereto, the diameter of first roller-shaped float member 141 and the diameter of the second roller-shaped float member 241 may be different from each other as long as the diameter of each float member is smaller than the extending length L₂ of float unit 240 and greater than the thickness T of plate-shaped float member 242.

Thus, by configuring float unit 240 in such a manner, when float unit 240 is sliding along the lower surface of rubber bag 120, first roller-shaped float members 141 and second roller-shaped float members 241 can contact rubber bag 120 by rolling against the lower surface thereof. As a result, it is possible to reduce the frictional resistance when float unit 240 is sliding along the lower surface of rubber bag 120. Thus, it is possible to prevent rubber bag 120 from being worn out. In the present embodiment, since both ends of float unit 240 are disposed with the roller-shaped float members, compared to float unit 140 according to the first embodiment, the frictional resistance between float unit 240 and the lower surface of rubber bag 120 can be further reduced.

Further, by increasing the extending length of float unit 240 while reducing the maximum thickness thereof, it is possible to ensure float unit 240 a certain volume so as to obtain sufficient buoyancy in insulation oil 130. As a result, it is possible to reduce the dead region of the oil level gauge. The reduction of the dead zone allows to make housing 110 smaller, and thereby making the conservator compact. In addition, it is also possible to reduce the required amount of insulation oil 130. Furthermore, the adoption of a dial typed oil level gauge allows to produce the conservator cheaper.

Hereinafter, a conservator according to a third embodiment of the present invention will be described with reference to the drawings. It should be noted that since the conservator according to the present embodiment is different from the conservator according to the first embodiment only in the configuration of the float unit, the descriptions about the other components will not be repeated.

### Third Embodiment

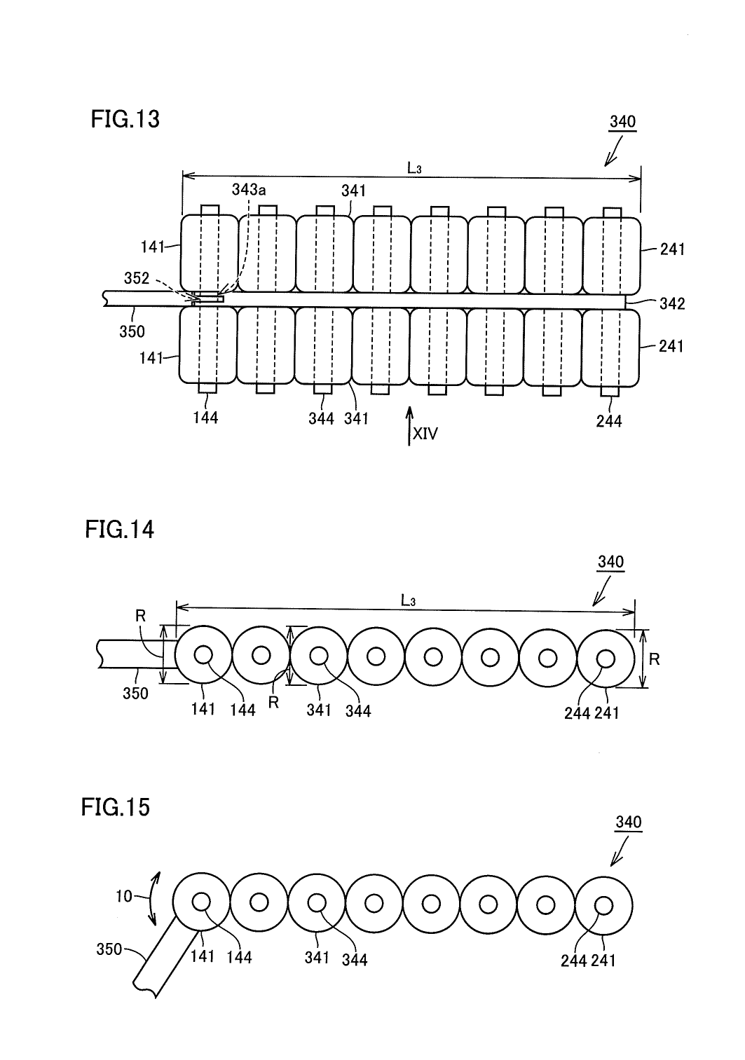

FIG. 13 is a planar view illustrating the configuration of a float unit of an oil level gauge in a conservator according to the third embodiment of the present invention. FIG. 14 is a view illustrating the float unit viewed from the direction of an arrow XIV in FIG. 13. FIG. 15 is a view illustrating a state in which an arm is swung relative to the float unit according to the third embodiment. FIG. 15 is viewed from the same direction as FIG. 14.

As illustrated in FIGS. 13 and 14, a float unit 340 includes a plate-shaped float member 342 which is long in length and narrow in width, and first pin 144 of a cylindrical shape which serves as a first shaft member provided at one end of plate-shaped float member 342 and configured to join plate-shaped float member 342 and arm 350 in such a manner that they are swingable to each other.

The other end of arm 350 is provided with a through hole 352 penetrating arm 350 in a direction perpendicular to the swinging direction of arm 150. The other end of arm 350 is made thinner than the other parts. One end of plate-shaped float member 342 is formed with a groove 343a for housing therein the other end of arm 350. One end of plate-shaped float member 342 is provided with a first through hole penetrating plate-shaped float member 342 in the width direction thereof.

The diameter of through hole 352 of arm 350 and the diameter of the first through hole of plate-shaped float member 342 each is made slightly larger than the diameter of first pin 144. Thus, after engaging the other end of arm 350 into the one end of plate-shaped float member 342, first pin 144 is inserted into through hole 352 of aim 350 and the first through hole of plate-shaped float member 342, and thereby, float unit 340 can be connected to aim 350, swingable relative to arm 350 as indicated by arrow 10 in FIG. 15. Note that both ends of first pin 144 are swaged so as to prevent the same from falling off.

Float unit 340 further includes second pin 244 which serves as a second shaft part provided at the other end of the plate-shaped float member 342 in parallel to first pin 144. The other end of plate-shaped float member 342 is provided with a second through hole penetrating plate-shaped float member 342 in the width direction thereof. The diameter of the second through hole is slightly larger than the diameter of second pin 244.

Furthermore, float unit 340 includes a plurality of third pins 344, each of which serves as a third shaft and are provided in parallel to first pin 144 between first pin 144 and second pin 244 with a distance separating each other. A plurality of third through holes are provided between the first through hole and the second through hole in plate-shaped float member 342. The plurality of third through holes are disposed to penetrate plate-shaped float member 342 in the thickness direction thereof and spaced by a distance from one another. The diameter of each third through hole is slightly larger than the diameter of each third pin 344.

In the present embodiment, float unit 340 further includes first roller-shaped float member 141 rotatably inserted around first pin 144. Specifically, there are two of first roller-shaped float members 141 which are inserted through by first pin 144. The diameter R of each first roller-shaped float member 141 is greater than the thickness T of plate-shaped float member 342. The number of first roller-shaped float members 141 is not limited to two, it may be one or more.

Two of first roller-shaped float members 141 are arranged in such a manner that one is inserted around first pin 144 from one end thereof and the other is inserted around first pin 144 from the other end thereof so as to sandwich therebetween plate-shaped float member 342.

In the present embodiment, float unit 340 further includes second roller-shaped float member 241 rotatably inserted around second pin 244. Specifically, there are two of second roller-shaped float members 241 which are inserted through by second pin 244. The diameter R of each second roller-shaped float member 241 is greater than the thickness T of plate-shaped float member 342. Two of second roller-shaped float members 241 are arranged in such a manner that one is inserted around second pin 244 from one end thereof and the other is inserted around second pin 244 from the other end thereof so as to sandwich therebetween plate-shaped float member 342. Second pin 244 is inserted into the second through hole, and both ends of second pin 244 are swaged so as to prevent the same from falling off The number of second roller-shaped float members 241 is not limited to two, it may be one or more.

In the present embodiment, float unit 340 further includes a plurality of third roller-shaped float members 341 rotatably inserted around each third pin 344. Specifically, there are two of third roller-shaped float members 341 which are inserted through by each third pin 344. The diameter R of each third roller-shaped float member 341 is greater than the thickness of plate-shaped float member 342. Two third roller-shaped float members 341 are arranged in such a manner that one is inserted around each third pin 344 from one end thereof and the other is inserted around the same third pin 344 from the other end thereof so as to sandwich therebetween plate-shaped float member 342. In the side view, the plurality of third roller-shaped float members 341 are line up in the extending direction of float unit 340. Each third pin 344 is inserted into each third through hole, and both ends of each third pin 344 are swaged so as to prevent the same from falling off The number of third roller-shaped float members 241 inserted around each third pin 344 is not limited to two, it may be one or more.

A length L₃ between a tangent line to the outer edge of first roller-shaped float member 141 disposed outer to third roller-shaped float member 341 and a tangent line to the outer edge of second roller-shaped float member 341 disposed outer to third roller-shaped float member 341 is defined as the extending length of float unit 340.

As described above, the extending length of float unit 340 is greater than the maximum thickness of float unit 340. In other words, the extending length L₃ of float unit 340 is greater than the diameter R of each of first roller-shaped float members 141, second roller-shaped float members 241 and third roller-shaped float members 341.

In the present embodiment, although the diameter of first roller-shaped float member 141 is configured to be the same as the diameter of second roller-shaped float member 241 and the diameter of third roller-shaped float member 341 but not limited thereto, the diameter of first roller-shaped float member 141, the diameter of the second roller-shaped float member 241 and the diameter of third roller-shaped float member 341 may be different from each other as long as the diameter of each float member is smaller than the extending length L₃ of float unit 340 and greater than the thickness of plate-shaped float member 342.

Thus, by configuring float unit 340 in such a manner, when float unit 340 is sliding along the lower surface of rubber bag 120, first roller-shaped float members 141, second roller-shaped float members 241 and third roller-shaped float members 341 can contact rubber bag 120 by rolling against the lower surface thereof. As a result, it is possible to reduce the frictional resistance when float unit 340 is sliding along the lower surface of rubber bag 120. Thus, it is possible to prevent rubber bag 120 from being worn out. In the present embodiment, since the entire float unit 240 is disposed with the roller-shaped float members, compared to float unit 240 according to the second embodiment, the frictional resistance between float unit 340 and the lower surface of rubber bag 120 can be further reduced.

Further, by increasing the extending length of float unit 340 while reducing the maximum thickness thereof, it is possible to ensure float unit 340 a certain volume so as to obtain sufficient buoyancy in insulation oil 130. As a result, it is possible to reduce the dead region of the oil level gauge. The reduction of the dead zone allows to make housing 110 smaller, and thereby making the conservator compact. In addition, it is also possible to reduce the required amount of insulation oil 130. Furthermore, the adoption of a dial typed oil level gauge allows to produce the conservator cheaper.

Hereinafter, a conservator according to a fourth embodiment of the present invention will be described with reference to the drawings. It should be noted that since the conservator according to the present embodiment is different from the conservator according to the first embodiment only in the configuration of the float unit, the descriptions about the other components will not be repeated.

### Fourth Embodiment

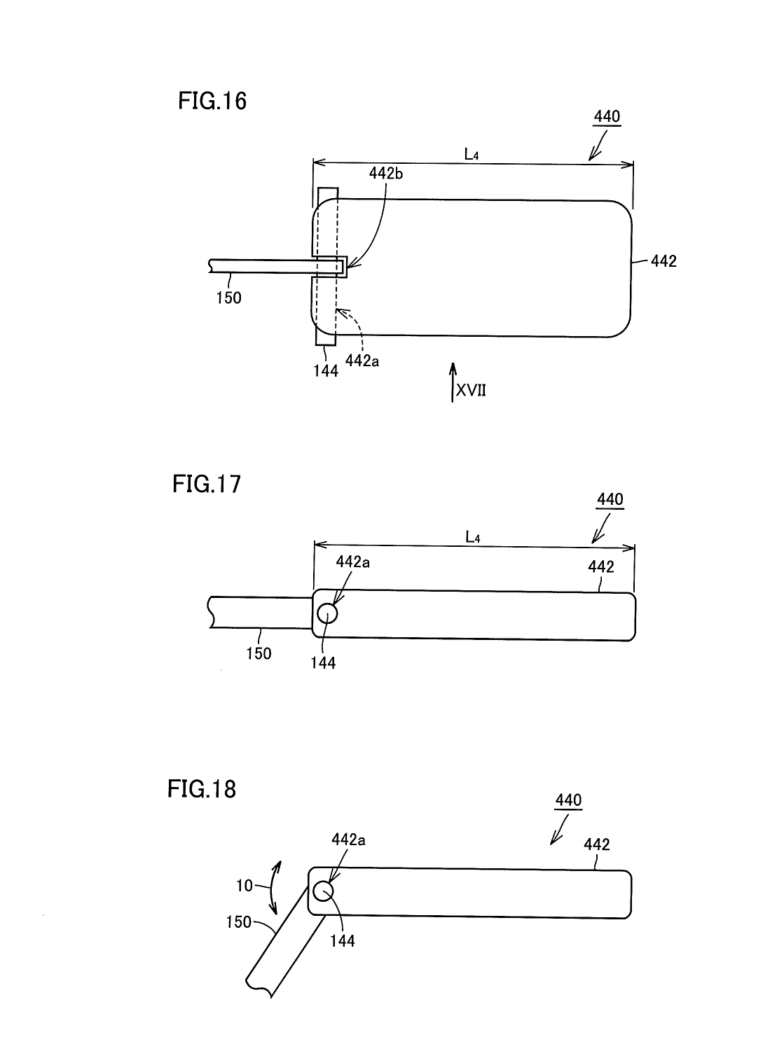

FIG. 16 is a planar view illustrating the configuration of a float unit of an oil level gauge in a conservator according to the fourth embodiment of the present invention. FIG. 17 is a view illustrating the float unit viewed from the direction of an arrow XVII in FIG. 16. FIG. 18 is a view illustrating a state in which an arm is swung relative to the float unit according to the fourth embodiment. FIG. 18 is viewed from the same direction as FIG. 17.

As illustrated in FIGS. 16 and 17, a float unit 440 includes a plate-shaped float member 442, and first pin 144 of a cylindrical shape which serves as a first shaft member provided at one end of plate-shaped float member 442 and configured to join plate-shaped float member 442 and arm 150 in such a manner that they are swingable to each other.

The other end of arm 150 is provided with a through hole 152 penetrating arm 150 in a direction perpendicular to the swinging direction of arm 150. One end of plate-shaped float member 442 is formed with a through hole 442a penetrating plate-shaped float member 442 in the width direction thereof and a recess 442b for housing therein the other end of arm 150.

The diameter of through hole 152 of arm 150 and the diameter of through hole 442a of plate-shaped float member 442 each is made slightly larger than the diameter of first pin 144. Thus, after locating the other end of arm 150 inside recess 442b, first pin 144 is inserted into through hole 152 of arm 150 and through hole 442a of plate-shaped float member 442, float unit 440 can be connected to arm 150, swingable relative to arm 150 as indicated by arrow 10 in FIG. 15. Note that both ends of first pin 144 are swaged so as to prevent the same from falling off.

A length L₄ between one end of plate-shaped float member 442 and the other end of plate-shaped float member 442 is defined as the extending length of float unit 440. As described above, the extending length of float unit 440 is greater than the maximum thickness T of float unit 440.

Thus, by increasing the extending length of float unit 440 while reducing the maximum thickness thereof, it is possible to ensure float unit 440 a certain volume so as to obtain sufficient buoyancy in insulation oil 130. As a result, it is possible to reduce the dead region of the oil level gauge. The reduction of the dead zone allows to make housing 110 smaller, and thereby making the conservator compact. In addition, it is also possible to reduce the required amount of insulation oil 130. Furthermore, the adoption of a dial typed oil level gauge allows to produce the conservator cheaper.

It should be understood that the embodiments disclosed herein have been presented for the purpose of illustration and description but not limited in all aspects. It is intended that the scope of the present invention is not limited to the description above but defined by the scope of the claims and encompasses all modifications equivalent in meaning and scope to the claims.

### REFERENCE SIGNS LIST

1, 130; insulation oil; 100: conservator; 110: housing; 111: flange; 112: open valve; 113: opening; 120: rubber bag; 140, 240, 340, 440: float unit; 141: first roller-shaped float member; 142, 242, 342, 442: plate-shaped float member; 142a, 242a, 242b: curved surface; 143, 243: joining member; 144: first pin; 150, 350: arm; 151: swinging fulcrum; 152, 352, 442a: through hole; 160: dial display unit; 161: character display face; 162: pointer; 241: second roller-shaped float member; 244: second pin; 341: third roller-shaped float member; 343a: groove; 344: third pin; 442b: recess

1. A conservator comprising:
a housing that houses an insulation oil;
a rubber bag that inflates or deflates inside said housing so as to contact an oil surface of said insulation oil; and
an oil level gauge that detects an oil level of said insulation oil housed in said housing,
said oil level gauge including a float unit, an arm connected to one end of said float unit, and a dial display unit that displays said oil level in response to an angle of said arm,
said float unit being swingably connected to said arm, extending away from said arm along a lower surface of said rubber bag,
the length of said float unit in the extending direction thereof being larger than the maximum thickness of said float unit, and
said arm being configured to shape in accordance with the inflated shape of said rubber bag as said float unit is being sandwiched between a bottom surface of said housing and said lower surface of said rubber bag.

2. The conservator according to claim 1, wherein
said float unit includes a plate-shaped float member, and a first shaft member provided at one end of said plate-shaped float member and configured to join said plate-shaped float member and said arm in such a manner that said plate-shaped float member and said arm are swingable to each other.

3. The conservator according to claim 2, wherein
said float unit further includes a first roller-shaped float member rotatably inserted around said first shaft member,
said first roller-shaped float member contacts said rubber bag by rolling against said lower surface thereof.

4. The conservator according to claim 3, wherein
said float unit further includes a second shaft member disposed at the other end of said plate-shaped float member and configured to be in parallel to said first shaft member, and a second roller-shaped float member rotatably inserted around said second shaft member,
said second roller-shaped float member contacts said rubber bag by rolling against said lower surface thereof.

5. The conservator according to claim 4, wherein
said float unit further includes a plurality of third shaft members disposed with a spacing from one another between said first shaft member and said second shaft member and configured to be in parallel to said first shaft member, and a plurality of third roller-shaped float members rotatably inserted around said third shaft members, respectively,
the plurality of said third roller-shaped float members contact said rubber bag by rolling against said lower surface thereof along the extending direction of said float unit.
